(19) United States
(12) Patent Application Publication
(10) Pub. No.: US 2011/0225259 A1
(43) Pub. Date: Sep. 15, 2011

(54) SYSTEM AND METHOD FOR COMMUNICATING SOFTWARE APPLICATIONS TO A MOTOR VEHICLE

(75) Inventors: Michael J. Quinn, Troy, MI (US); Richard C. Vanitvelt, Metamora, MI (US); Anthony G. Lobaza, Bloomfield Hills, MI (US); Alfred C. Tom, San Francisco, CA (US)

(73) Assignee: GM GLOBAL TECHNOLOGY OPERATIONS LLC, Detroit, MI (US)

(21) Appl. No.: 13/026,923

(22) Filed: Feb. 14, 2011

Related U.S. Application Data
(60) Provisional application No. 61/313,552, filed on Mar. 12, 2010.

(51) Int. Cl. G06F 15/16

(52) U.S. Cl. 709/217

(57) ABSTRACT

A system and method for selecting, downloading, and storing software applications to a motor vehicle includes a user selecting an application to add to the motor vehicle. Upon selection, the a vehicle service provider prepares the application for delivery to the vehicle by packaging the requested application source files and digitally signs the application source files. If the selection was made from the vehicle, the application package is delivered to the vehicle upon request. Otherwise, the vehicle synchronizes with the service provider at a later time. During this synchronization process, the vehicle determines that an application must be downloaded and requests the application package from the service provider. The application source is contained within one digitally signed application package that is delivered to the vehicle. The vehicle verifies the digital signature of the package. If the digital signature is valid, the contents are unpacked and stored locally by the vehicle.

### CROSS-REFERENCE TO RELATED APPLICATIONS

This application claims the benefit of U.S. Provisional Application No. 61/313,552, filed on Mar. 12, 2010. The disclosure of the above application is incorporated herein by reference.

### FIELD

The present disclosure relates to a system and method of communicating software applications to a motor vehicle, and more particularly to a system and method of selecting, communicating to and storing software applications in a motor vehicle.

### BACKGROUND

The statements in this section merely provide background information related to the present disclosure and may or may not constitute prior art.

Motor vehicles equipped with communication systems have the capability of communicating between various entities. For example, a vehicle communications system may communicate with a call center, another vehicle, an EMS service, and a land network such as the internet-infrastructure, a public switching telephone network, or any other telecommunications network. These communication systems are typically integrated with controls, audio systems, and interactive display devices to provide information to the user of the motor vehicle. The information may be communicated in the form of light displays on the instrument panel of the motor vehicle, calls made to the motor vehicle, or as information displayed on the interactive display device. This information may be functional in nature, such as GPS location, vehicle performance information, warning messages and/or instructions, etc., and in the form of entertainment information, such as music, audio books, movies, games, etc. In many cases, this information is generated by software applications and the information is communicated to the motor vehicle via the communication system. While these systems have performed well in the past, there is room in the art for a system and method of selecting, downloading, and storing software applications to a motor vehicle in order to personalize the motor vehicle and to reduce network bandwidth and latency during operation of the software applications.

### SUMMARY

The present invention provides a system and method for selecting, downloading, and storing software applications to a motor vehicle. A user selects an application to add to the motor vehicle. This selection can be made from either within the vehicle or from any Internet-enabled device. Upon selection, the a vehicle service provider prepares the application for delivery to the vehicle by packaging the requested application source files and digitally signs the application source files. If the selection was made from the vehicle, the application package is delivered to the vehicle upon request. Otherwise, the vehicle synchronizes with the service provider at a later time. During this synchronization process, the vehicle determines that an application must be downloaded and requests the application package from the service provider. The application source is contained within one digitally signed application package that is delivered to the vehicle. This package can be delivered to the vehicle either using an embedded network connection, a connection to a mobile device, or a USB drive. The vehicle verifies the digital signature of the package. If the digital signature is valid, the contents are unpacked and stored locally by the vehicle. Therefore, an application is launched by loading a local file that is already stored in the vehicle.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a schematic diagram of a system for selecting and communicating software applications to a motor vehicle;

FIG. 2 is a schematic diagram of an exemplary infotainment module within the motor vehicle;

FIG. 3 is a flowchart illustrating an embodiment of a method for selecting, communicating, and storing software applications to a motor vehicle; and

FIG. 4 is a flowchart illustrating another embodiment of a method for selecting, communicating, and storing software applications to a motor vehicle.

### DETAILED DESCRIPTION

The following description is merely exemplary in nature and is not intended to limit the present disclosure, application, or uses.

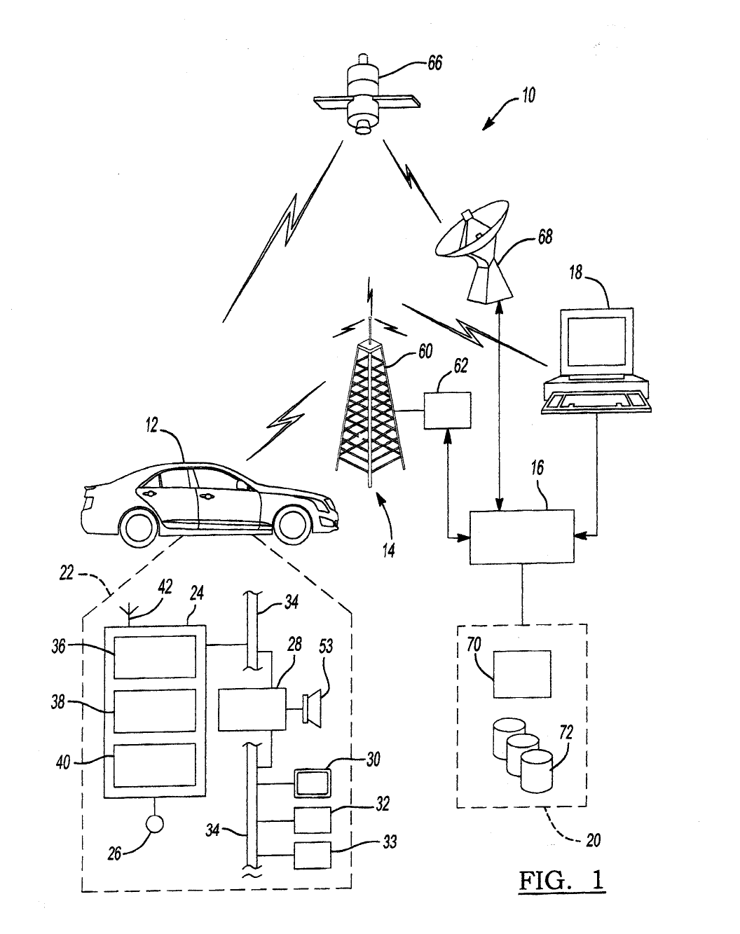

Referring to FIG. 1, an exemplary system for selecting and communicating software applications to a motor vehicle is generally indicated by reference number 10. The system 10 generally includes a vehicle 12, one or more wireless carrier systems 14, a land communications network 16, a computer 18, and a service provider 20. It should be understood that the disclosed method can be used with any number of different systems and is not specifically limited to the operating environment shown here.

The vehicle 12 is depicted in the illustrated embodiment as a passenger car, but it should be appreciated that any other vehicle including motorcycles, trucks, sports utility vehicles (SUVs), recreational vehicles (RVs), marine vessels, aircraft, etc., can also be used. The vehicle 12 includes a vehicle electronics system 22. The electronics system 22 generally includes a network module 24, one or more control inputs 26, an audio system 28, a visual display 30, an infotainment module 32, as well as a number of vehicle system modules (VSMs) 33. Some of these devices can be connected directly to the network module 24 whereas others are indirectly connected using one or more network connections, such as a communications bus 34. Examples of suitable network connections include a controller area network (CAN), a media oriented system transfer (MOST), a local interconnection network (LIN), a local area network (LAN), and other appropriate connections such as Ethernet or others that conform with known ISO, SAE and IEEE standards and specifications, to name but a few.

In the example provided, the network module 24 is a telematics unit which is an OEM-installed device that enables wireless voice and/or data communication over the wireless carrier system 14 (shown schematically in FIG. 1) and via wireless networking so that the vehicle can communicate with the vehicle service provider 20, other telematics-enabled vehicles, or some other entity or device. The network module 24 preferably uses radio transmissions to establish a communications channel (a voice channel and/or a data channel) with the wireless carrier system 14 so that voice and/or data transmissions can be sent and received over the channel. By providing both voice and data communication, network module 24 enables the vehicle to offer a number of different services including those related to navigation, telephony, emergency assistance, diagnostics, infotainment, etc. It should be appreciated that the network module 24 may be limited to data communication without departing from the scope of the present invention. Data can be sent either via a data connection, such as via packet data transmission over a data channel, or via a voice channel. It should be appreciated that the network unit 24 may be a wi-fi connection or a Bluetooth connection without departing from the scope of the present invention.

The network module 24 can be used to provide a diverse range of vehicle services that involve wireless communication to and/or from the vehicle 12. Such services include: turn-by-turn directions and other navigation-related services that are provided in conjunction with a GPS-based vehicle navigation module; airbag deployment notification and other emergency or roadside assistance-related services that are provided in connection with one or more collision sensor interface modules such as a body control module (not shown); diagnostic reporting using one or more diagnostic modules; and infotainment-related services for the infotainment module 32. It should be understood that at least some of the aforementioned modules could be implemented in the form of software instructions saved internal or external to the network module 24, implemented as hardware components located internal or external to the network module 24, or integrated and/or shared with each other or with other systems located throughout the vehicle. In the event that the modules are implemented as VSMs 33 located external to the telematics unit 32, they could utilize the vehicle bus 34 to exchange data and commands with the network module 24 and the infotainment module 32.

According to one embodiment, the network module 24 utilizes cellular communication according to wide-area wireless standards and thus includes a standard cellular chipset 36 for voice communications for hands-free calling, a wireless modem for data transmission, an electronic processing device 38, one or more digital memory devices 40, and a dual antenna 42. It should be appreciated that the modem can either be implemented through software that is stored in the network module 24 and is executed by the processor 38, or it can be a separate hardware component located internal or external to the network module 24. The modem can operate using any number of different standards or protocols such as EVDO, CDMA, GPRS, and EDGE. Wireless networking between the vehicle and other networked devices can also be carried out using the network module 24. For this purpose, the network module 24 can be configured to communicate wirelessly according to one or more wireless protocols, such as any of the IEEE 802.11 protocols, WiMAX, or Bluetooth. When used for packet-switch data communication such as TCP/IP, the network module 24 can be configured with a static IP address or can set up to automatically receive an assigned IP address from another device on the network such as a router or from a network address server.

The processor 38 can be any type of device capable of processing electronic instructions including microprocessors, microcontrollers, host processors, controllers, vehicle communication processors, and application specific integrated circuits (ASICs). It can be a dedicated processor used only for the network module 24 or can be shared with other vehicle systems.

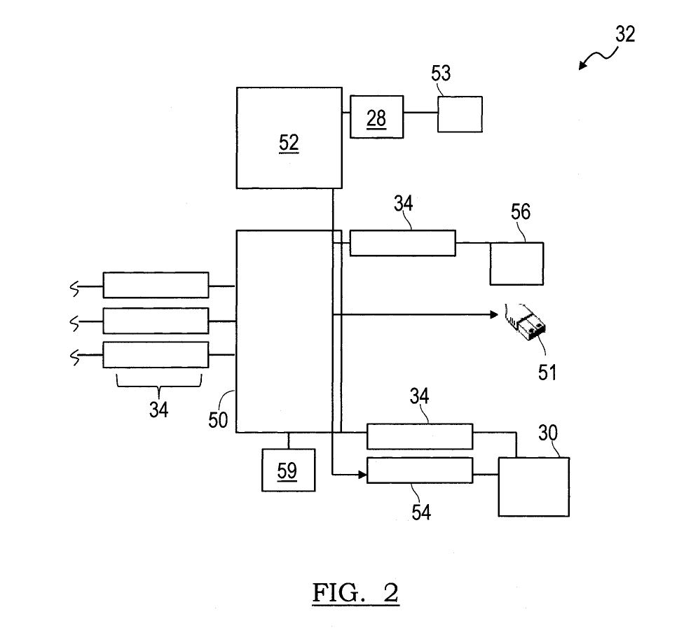

Turning to FIG. 2, the infotainment module 32 is illustrated in further detail. The infotainment module 32 may offer AM/FM or satellite radio, CD/DVD player for music and video, navigation system, data and multi-media ports (USB, Blue tooth, line in, line out, video in) as well as general and vehicle status information. The infotainment module 32 may also be able to display webpages, movies, television programs, videogames and/or other information that is downloaded by the infotainment module 32 via the network module 24.

The infotainment module 32 generally includes a processor 50 in communication with the network module 24 via the network bus 34. The processor 50 can be any type of device capable of processing electronic instructions including microprocessors, microcontrollers, host processors, controllers, vehicle communication processors, digital signature processing, and application specific integrated circuits (ASICs). Generally, the processor 50 controls the user interface, bus interface, and network interface as well as GPS navigation and touch screen control. It is also used to process and output video data from multiple sources. The processor 50 can have various input and output (I/O) ports that allow a user of the motor vehicle 12 to connect with the infotainment module 32. For example, the processor 50 can communicate with a USB device 51.

The processor 50 communicates with an audio processor 52. The audio processor 52 performs I/Q demodulation and outputs digital audio and data. This data includes functions such as volume, treble, bass and sound effects, as well as more sophisticated features like mixing input channels and digitally process multiple channels, performing sound effects processing such as Dolby® Pro Logic® II, SRS® Circle Surround™ II, TruSound and other audio algorithms. The audio processor 52 outputs to the audio system 28 that includes a plurality of speakers 53.

The processor 50 also communicates via network bus 34 or a serial link to the display device 30. In the example provided, the display device 30 is an interactive display device that is preferably a graphics display, such as a touch screen on the instrument panel or a heads-up display reflected off of the windshield, and can be used to provide a multitude of input and output functions. The display device 30 is preferably controlled via touchscreen input controls 54, though various other input controls may be used to control the infotainment module 32, such as input controls 26 associated with the network module 24. In one embodiment, the input controls 26 and 54 are combined or integrated on the instrument panel of the motor vehicle or through the touchscreen of the display device 30. It should be appreciated that various other vehicle user interfaces and display devices can also be utilized. For example, the processor 50 may also communicate via the bus bar 34 with a separate monitor or other display device 56, either in a service station or an integrated video display located in a back seat area of the motor vehicle 12.

Finally, the processor 50 communicates with a permanent memory storage device 59. The memory 59 is used to store data within the infotainment module 32. It should be appreciated that the memory 59 may be separate from the infotainment module 32, or part of another module, such as the memory 40 within the network module 24

Returning to FIG. 1, apart from the infotainment module 32, the vehicle 12 can include other vehicle system modules (VSMs) 33 in the form of electronic hardware components that are located throughout the vehicle and typically receive input from one or more sensors and use the sensed input to perform diagnostic, monitoring, control, reporting and/or other functions. Each of the VSMs 33 is preferably connected by communications bus 34 to the other VSMs, as well as to the network module 24 and the infotainment module 32, and can be programmed to run vehicle system and subsystem diagnostic tests. As examples, one VSM 33 can be an engine control module (ECM) that controls various aspects of engine operation such as fuel ignition and ignition timing, another VSM 33 can be a powertrain control module that regulates operation of one or more components of the vehicle powertrain, and another VSM 33 can be a body control module that governs various electrical components located throughout the vehicle, like the vehicle's power door locks and headlights. It should be appreciated that the above-mentioned VSMs are only examples of some of the modules that may be used in vehicle 12, as numerous others are also possible.

The wireless carrier system 14 is preferably a cellular telephone system that includes a plurality of cell towers 60 (only one shown), one or more mobile switching centers (MSCs) 62, as well as any other networking components required to connect the wireless carrier system 14 with the land network 16. Cellular system 14 can implement any suitable communications technology, including for example, analog technologies such as AMPS, or the newer digital technologies such as CDMA (e.g., CDMA2000) or GSM/GPRS.

The wireless carrier system 14 may also include satellite based communications which can be used to provide uni-directional or bi-directional communication with the vehicle 12. This can be done using one or more communication satellites 66 and an uplink transmitting station 68. Uni-directional communication can be, for example, satellite radio services, wherein programming content (news, music, etc.) is received by transmitting station 68, packaged for upload, and then sent to the satellite 66, which broadcasts the programming to subscribers. Bi-directional communication can be, for example, satellite telephony services using satellite 66 to relay telephone communications between the vehicle 12 and the station 68. It should be appreciated that the wireless carrier system 14 is only exemplary and may include any other number of telecommunications systems and methods.

The land network 16 may be a conventional land-based telecommunications network that is connected to one or more landline telephones and connects the wireless carrier system 14 to the vehicle service provider 20 and the computer 18. For example, the land network 16 may include a public switched telephone network (PSTN) such as that used to provide hardwired telephony, packet-switched data communications, and preferably the Internet infrastructure. One or more segments of land network 16 could be implemented through the use of a standard wired network, a fiber or other optical network, a cable network, power lines, other wireless networks such as wireless local area networks (WLANs), or networks providing broadband wireless access (BWA), or any combination thereof. Furthermore, the vehicle service provider 20 and computer 18 need not be connected via the land network 16, but could include wireless equipment so that it can communicate directly with a wireless network, such as the wireless carrier system 14.

The computer 18 can be one of a number of computers accessible via a private or public network such as the Internet. Exemplary computers 18 include home personal computers, portable computers, PDA's, mobile phones, and any other internet-enabled device. Each such computer 18 can be used for one or more purposes, such as a web server accessible by the vehicle via network module 24 and wireless carrier 14. Other such accessible computers 18 can be, for example: a service center computer where diagnostic information and other vehicle data can be uploaded from the vehicle via the network module 24; a client computer used by the vehicle owner or other subscriber for such purposes as accessing or receiving vehicle data or to setting up or configuring subscriber preferences or controlling vehicle functions; or a third party repository to or from which vehicle data or other information is provided, whether by communicating with the vehicle 12 or the vehicle service provider 20, or both. A computer 18 can also be used for providing Internet connectivity to assign an IP address to the vehicle 12.

The vehicle service provider 20 is designed to provide the vehicle electronics 22 with a number of different system back-end functions. These functions include providing software applications to the infotainment module 32 of the vehicle 12. Other functions may include diagnostic information, warning communications, etc. The vehicle service provider 20 can have various configurations but generally includes servers 70 and databases 72, either separate or combined, which communicate with the land network 16 to provide software applications and other services. Data transmissions to and from the land network 16 are passed to the servers 70 and/or databases 72. The servers 70 can store various software applications. The databases 72 can store account information such as subscriber authentication information, vehicle identifiers, profile records, behavioral patterns, and other pertinent subscriber information.

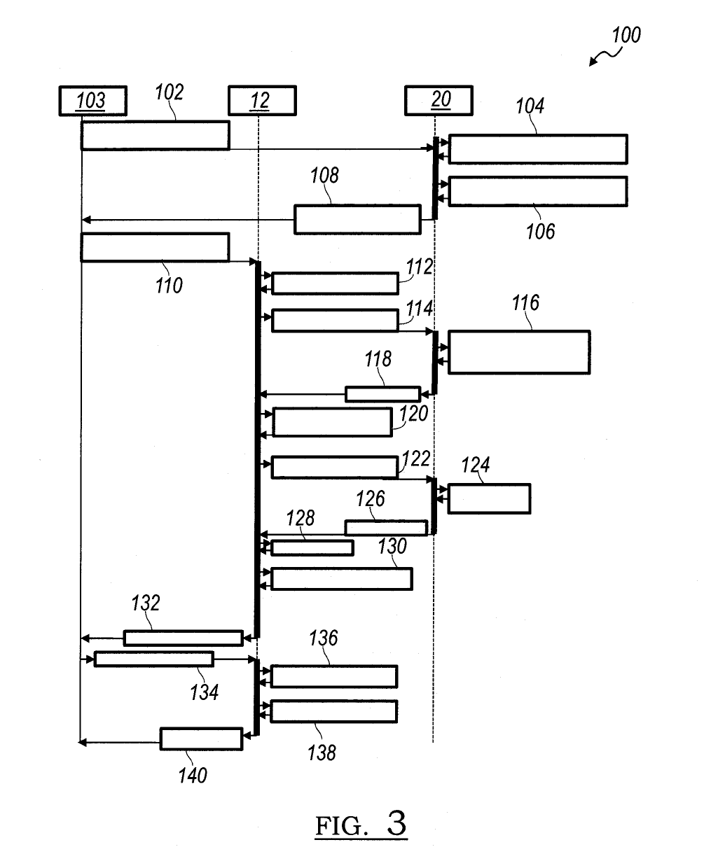

Turning now to FIG. 3, and with continued reference to FIGS. 1 and 2, a method of selecting, communicating, and storing software applications using the system 10 is generally indicated by reference number 100. The method 100 begins at step 102 where a user 103 uses the computer 18 to access the servers 70 of the vehicle service provider 20 to select a software application to download to the vehicle 12. The vehicle service provider 20 then packages the requested application source files and digitally signs the package at step 104. At step 106, the vehicle service center 20 associates the package with the user's vehicle 12 by accessing the database 72 and linking the package with a vehicle identifier unique to the vehicle 12. The vehicle service center 20 then communicates to the user 103 that the selection of the software application was successful at step 108.

At step 110 a synchronization process is initiated by the user 103. The synchronization process may be automatically initiated when the user 103 turns on the vehicle 12. Alternatively, the synchronization process may be initiated manually by the user 103 via the input controls 26 and/or 54 of the vehicle electronics 22. The synchronization process begins at step 112 where the infotainment module 32 retrieves the vehicle identifier stored in memory. The infotainment module 32 then communicates with the vehicle service center 20 via the network module 24 and the wireless network 18 and requests a list of applications associated with the vehicle identifier at step 114. The vehicle service center 20 then looks up all application packages associated with the unique vehicle identifier at step 116.

The list of applications associated with the vehicle identifier is then communicated back to the vehicle 12 via the wireless network 14 at step 118. The infotainment module 32 of the vehicle 12 then determines which applications have been already stored in memory 59 within the vehicle 12 at step 120. If an application has already been stored in memory 59, the method 100 proceeds to step 132. In addition, if the application has been stored in memory 59, the version of the application may be sent to the vehicle service center 20. The vehicle service center 20 then compares the application version number to the most recent, updated version of the application. If an application has not been stored in memory 59 or a new update is available, then the vehicle 12 sends a request to download the application or update at step 122 to the vehicle service center 20. The vehicle service center 20 then retrieves the application package at step 124 and digitally signs the application package at step 126 and communicates the signed application package to the vehicle 12. The vehicle 12 then verifies the digital signature at step 128 to confirm that the proper application package has been sent and that the service provider is legitimate. The infotainment module 32 then unpacks the application package, which may include an entire application or an update to an existing application, and stores the application locally within the memory 59 of the vehicle 12 at step 130. The synchronization process completes at step 132.

At step 134, the user 103 requests to launch the application by interacting with the input controls 26, 54 of the vehicle 12. The infotainment module 12 then retrieves the files from memory 59 associated with the requested application at step 136 and launches the application at step 138. The application is preferably launched using an application rendering engine, such as an HTML renderer, and loads the locally cached files into the rendering window of the display device 30. The method 100 ends at step 140 with the application ready to use by the user 103.

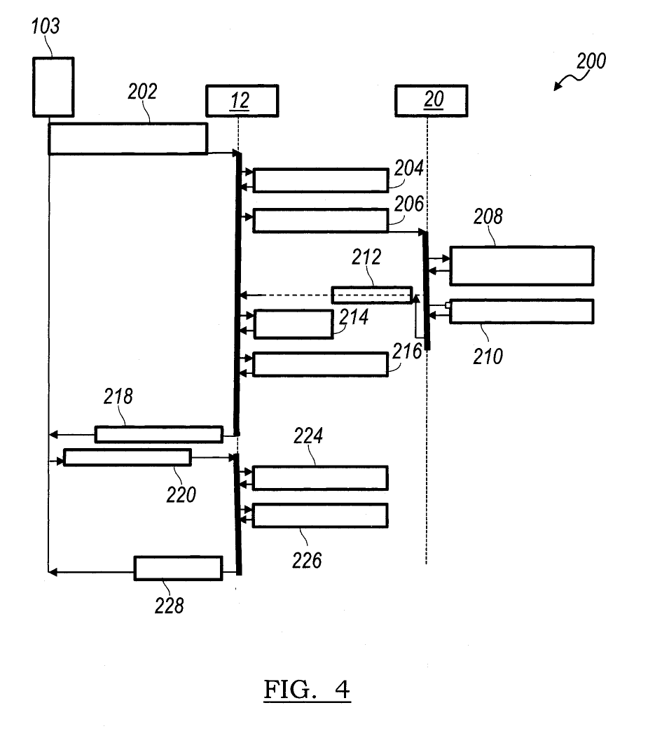

Turning to FIG. 4, and with continued reference to FIGS. 1 and 2, an alternate method for selecting, downloading, and storing a software application using the system 10 is generally indicated by reference number 200. The method 200 begins at step 202 where the user 103 uses the input controls 26 and/or 54 within the motor vehicle 12 to access the servers 70 of the vehicle service provider 20 to select a software application to download to the vehicle 12. At step 204 the infotainment module 32 retrieves the vehicle identifier stored in memory. Then the vehicle 12 sends a request to the vehicle service center 20 to download the selected application to the vehicle identifier at step 206. The vehicle service provider 20 then packages the requested application source files and digitally signs the package at step 208. At step 210, the vehicle service center 20 associates the package with the user's vehicle 12 by accessing the database 72 and linking the package with the vehicle identifier sent by the vehicle 12. The vehicle service center 20 then digitally signs the application package at step 212 and communicates the signed application package to the vehicle 12.

The vehicle 12 then verifies the digital signature at step 214 to confirm that the application package has been sent from a trusted or verified source. The infotainment module 32 then unpacks the application package and stores the application locally within the memory 59 of the vehicle 12 at step 216. The application download process completes at step 218.

At step 220, the user 103 requests to launch the application by interacting with the input controls 26, 54 of the vehicle 12. The infotainment module 12 then retrieves the files from memory 59 associated with the requested application at step 224 and launches the application at step 226. The application is preferably launched using an application rendering engine, such as an HTML renderer, and loads the locally cached files into the rendering window of the display device 30. The method 200 ends at step 228 with the application ready to use by the user 103.

The ability to download an application to the vehicle 12 allows the vehicle 12 to keep pace with consumer electronics and maintain market relevance. By enabling a user to choose the applications to be downloaded to the vehicle 12, the vehicle 12 can be personalized to each user. Storing (or caching) application files and resources locally within the vehicle 12 reduces the network bandwidth required to run the applications. Storing (or caching) application files also decreases the latency associated with launching an Internet-based application. The stored application only needs to utilize the network connection to retrieve real-time data.

In alternate embodiments of the above methods 100, 200, the infotainment module 32 can receive and run applications from an external device connected to the infotainment module 32, either via a wireless connection or via a USB connection. For example, a hand-held media device, such as an iPhone (reg.) or other smart phone, can be used to download the application packages. The media device is then connected with the infotainment module 32 which then runs the applications upon request from the media device.

The description of the invention is merely exemplary in nature and variations that do not depart from the gist of the invention are intended to be within the scope of the invention. Such variations are not to be regarded as a departure from the spirit and scope of the invention.

The following is claimed:

1. A method for selecting, downloading, and storing software applications to a motor vehicle, the method comprising:
selecting a software application from a software application source;
preparing the software application for delivery;
synchronizing the motor vehicle with the software application source;
delivering the software application to the motor vehicle;
preparing the software application for use by the motor vehicle; and
storing the software application in the motor vehicle for future use.

2. The method of claim 1 wherein the step of selecting a software application includes selecting a software application from a personal computer in communication with the software application source.

3. The method of claim 1 wherein the step of selecting a software application includes selecting a software application from a mobile hand-held device in communication with the software application source.

4. The method of claim 1 wherein the step of selecting a software application includes selecting a software application from a module within the motor vehicle in communication with the software application source.

5. The method of claim 1 further comprising communicating to a user of the motor vehicle that the selection of the software application was successful.

6. The method of claim 1 wherein the step of synchronizing the motor vehicle with the software application source includes a user manually initiating the synchronization or the motor vehicle automatically initiating the synchronization.

7. The method of claim 1 wherein preparing the software application for delivery includes packaging the software application and associating the package with the motor vehicle by accessing a database with a vehicle identifier unique to the motor vehicle and linking the package with the vehicle identifier via a digital signature packaged with the software application.

8. The method of claim 7 wherein the step of synchronizing the motor vehicle with the software application source includes the motor vehicle communicating with the software application source and requesting a list of software applications associated with the vehicle identifier.

9. The method of claim 8 wherein the step of synchronizing the motor vehicle with the software application further includes communicating the list of applications from the software application source to the motor vehicle.

10. The method of claim 9 wherein the step of synchronizing the motor vehicle with the software application further includes determining which software applications from the list of applications are stored in the motor vehicle and which software applications from the list of applications has not been stored in the motor vehicle.

11. The method of claim 10 wherein the step of delivering the software application to the motor vehicle includes delivering any software applications from the list of applications to the motor vehicle that are not stored in the motor vehicle.

12. The method of claim 11 wherein the step of preparing the software application for use by the motor vehicle includes verifying the digital signature to confirm that the proper software application package has been sent and unpacking the software application if the proper software package has been sent.

13. A method for downloading software applications to a motor vehicle, the method comprising:
requesting a list of software applications associated with a vehicle identifier unique to the motor vehicle from a software application source;
communicating the list of applications from the software application source to the motor vehicle;
comparing the list of applications to any software applications stored in a memory of the motor vehicle;
identifying which software applications from the list of applications are not stored in the memory of the motor vehicle;
communicating a list of the identified software applications to the software application source;
packaging the identified software applications and digitally signing the package;
delivering the package to the motor vehicle;
verifying the digital signature to confirm that the proper package has been sent to the motor vehicle and unpacking the package if the proper package has been sent; and
storing the software application in the motor vehicle for future use.

14. The method of claim 13 further comprising selecting a software application from the software application source.

15. The method of claim 14 wherein selecting a software application from the software application source includes selecting a software application using a personal computer in communication with the software application source.

17. The method of claim 14 wherein the step of selecting a software application includes selecting a software application using a mobile hand-held device in communication with the software application source.

18. The method of claim 14 wherein the step of selecting a software application includes selecting a software application using an infotainment module within the motor vehicle in communication with the software application source.

19. The method of claim 14 further comprising communicating to a user of the motor vehicle that the delivery, unpacking, and storing of the software package was successful.

20. The method of claim 14 wherein the step of requesting a list of software applications associated with a vehicle identifier unique to the motor vehicle from a software application source is initiated by a user manually initiating the request using an infotainment module in the motor vehicle or the motor vehicle automatically initiating the request when the motor vehicle is started by the user.
